(19) United States
(12) Patent Application Publication
(10) Pub. No.: US 2020/0312144 A1
(43) Pub. Date: Oct. 1, 2020

(54) MANAGEMENT DEVICE, MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/823,423

(22) Filed: Mar. 19, 2020

(30) Foreign Application Priority Data
Mar. 29, 2019 (JP) 2019-067300

(51) Int. Cl. G08G 1/0968; G01C 21/34; B60W 60/00

(52) U.S. Cl. CPC G08G 1/096816; B60W 60/0011; G01C 21/3453

(57) ABSTRACT

A management device, which guides a vehicle capable of automatically traveling, includes a generator that generates a route for guiding the vehicle, and a communicator that transmits information on the generated route to the vehicle and receives information on a route on which the vehicle has actually traveled from the vehicle. When a first route generated as a route of a first vehicle is different from a second route on which the first vehicle has actually traveled, the generator generates a third route based on the second route, and the communicator transmits information on the third route to a second vehicle that passes through the same two or more points as the first vehicle after the first vehicle.

Priority is claimed on Japanese Patent Application No. 2019-067300, filed Mar. 29, 2019, the content of which is incorporated herein by reference.

### BACKGROUND

### Field of the Invention

An aspect of the present invention relates to a management device, a management method, and a storage medium.

### Description of Related Art

In recent years, research has been conducted on automatically controlling vehicles. There is known an automatic valet parking device that applies the research, communicates with an automatically driven vehicle to guide the automatically driven vehicle to an empty space in a parking lot attached to a facility, and automatically parks the automatically driven vehicle (for example, see Published Japanese Translation No. 2005-284699 of the PCT International Publication for Patent Applications).

### SUMMARY

However, in the related art, when a monitoring facility in the parking lot is not sufficient, it is not possible to detect a situation where there are a fallen object and the like in a passage in the parking lot. Therefore, there are cases where a plurality of automatically driven vehicles are guided many times along a route that passes through a passage with the fallen object, and such a situation has not been sufficiently studied.

The present invention is achieved in view of the problems described above, and one object of the present invention is to provide a management device, a management method, and a storage medium, by which it is possible to smoothly guide an automatically driven vehicle to a destination in valet parking.

### Solution to Problem

A management device, a management method, and a storage medium according to the invention employ the following configurations.

(1): A management device according to an aspect of the invention is a management device, which guides a vehicle capable of automatically traveling, including: a generator that generates a route for guiding the vehicle; and a communicator that transmits information on the generated route to the vehicle and receives information on a route on which the vehicle has actually traveled from the vehicle, wherein, when a first route generated as a route of a first vehicle is different from a second route on which the first vehicle has actually traveled, the generator generates a third route based on the second route, and the communicator transmits information on the third route to a second vehicle that passes through the same two or more points as the first vehicle after the first vehicle.

(2) In the aspect (1), the generator generates a route of the second vehicle, and when the generated route of the second vehicle overlaps at least a part of the first route generated as the route of the first vehicle, the generator generates the third route by correcting the route of the second vehicle based on the second route.

(3) In the aspect (1) or (2), the generator generates a route of the second vehicle, and when the generated route of the second vehicle includes a detour point that is an interruption point of traveling along the first route generated as the route of the first vehicle and is a start point of the second route, the generator generates the third route by correcting the route of the second vehicle based on the second route.

(4) In any one of the aspects (1) to (3), the management device further includes a predictor that predicts that an abnormality has occurred when the number of vehicles, in which the route generated by the generator is different from the actually traveled route, exceeds a predetermined number.

(5) In the aspect (4), the predictor predicts that an abnormality has occurred in a passage in which the vehicle is traveling.

(6) In the aspect (4) or (5), when the abnormality predicted by the predictor is resolved, the generator generates a route similarly to a case where no abnormality is predicted by the predictor.

(7) In any one of the aspects (1) to (6), the management device further includes an inter-vehicle adjustor that, when the first route and the second route are different from each other, allows a vehicle with high outside world detection performance to travel with higher priority than a vehicle with low outside world detection performance among a plurality of vehicles that pass through the same two or more points as the first vehicle, and the generator generates the third route based on a route on which the vehicle with high outside world detection performance has actually traveled.

(8) In any one of the aspects (1) to (7), when the first route and the second route are different from each other, the management device allows a probe car with high outside world detection performance to travel and generates the third route based on a route on which the probe car has actually traveled.

(9) A management method according to an aspect of the invention is a management method implemented by a computer performing the steps of: generating a route for guiding a vehicle capable of automatically traveling; transmitting information on the generated route to the vehicle; receiving information on a route on which the vehicle has actually traveled from the vehicle; generating a third route based on a second route on which the first vehicle has actually traveled when a first route generated as a route of a first vehicle is different from the second route; and transmitting information on the third route to a second vehicle that passes through the same two or more points as the first vehicle after the first vehicle.

(10) A program according to an aspect of the invention is a program causing a computer to perform the steps of: generating a route for guiding a vehicle capable of automatically traveling; transmitting information on the generated route to the vehicle; receiving information on a route on which the vehicle has actually traveled from the vehicle; generating a third route based on a second route on which the first vehicle has actually traveled when a first route generated as a route of a first vehicle is different from the second route; and transmitting information on the third route to a second vehicle that passes through the same two or more points as the first vehicle after the first vehicle.

According to the aspects of (1) and (10), it is possible to smoothly guide an automatically driven vehicle to a destination in valet parking.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram schematically illustrating a scene in which a self-propelled parking event is performed.

FIG. 4 is a diagram illustrating an example of a configuration of a parking lot management device.

FIG. 5 is a diagram schematically illustrating an example of a travel route when an obstacle exists on a passage.

FIG. 6 is a diagram illustrating an example of detour-related information.

FIG. 7 is a diagram schematically illustrating an example of a travel route after the occurrence of an obstacle is predicted.

FIG. 8 is a diagram illustrating an example of third route information.

FIG. 9 is a diagram schematically illustrating an example of a travel route immediately after an abnormal state predicted for a detour point is resolved.

FIG. 10 is a flowchart illustrating an example of a process performed in a vehicle system of a first vehicle.

FIG. 11 is a flowchart illustrating an example of a route generation process performed in the parking lot management device.

FIG. 12 is a flowchart illustrating an example of a process performed in a vehicle system of a second vehicle.

FIG. 13 is a flowchart illustrating an example of a detour-related process performed in the parking lot management device.

FIG. 14 is a flowchart illustrating a continuation of the process of FIG. 13.

FIG. 15 is a flowchart illustrating an example of a release process performed in the parking lot management device.

FIG. 16 is a diagram illustrating an example of a travel route when an obstacle exists on a passage.

FIG. 17 is a diagram schematically illustrating an example of a travel route after the occurrence of an obstacle is predicted.

FIG. 18 is a diagram illustrating an example of a hardware configuration of an automatic driving control device of an embodiment.

### DESCRIPTION OF EMBODIMENTS

Hereinafter, an embodiment of a management apparatus, a management method, and a storage medium of the present invention will be described with reference to the drawings.

### First Embodiment

[Overall Configuration]

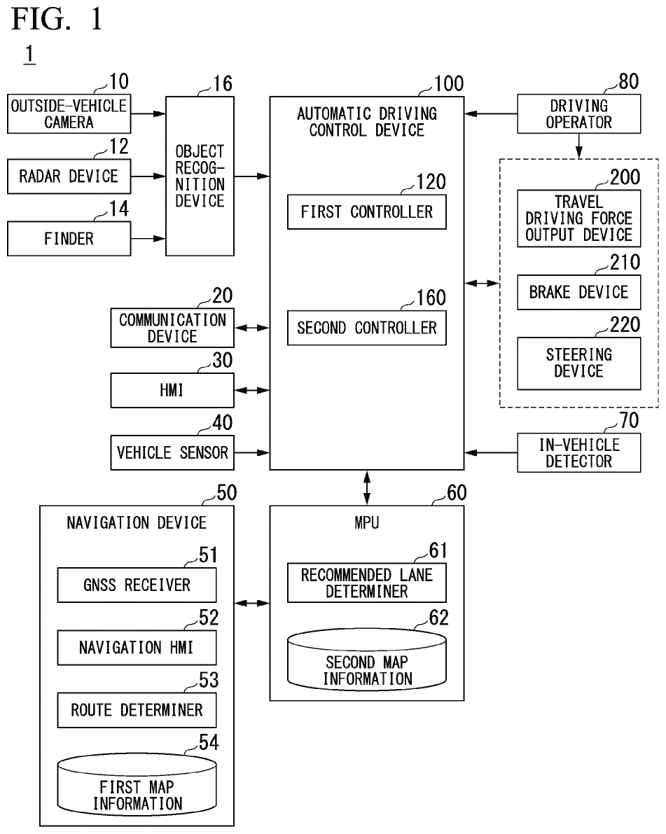

FIG. 1 is a configuration diagram of a vehicle system 1 using a vehicle control device according to an embodiment. A vehicle, in which the vehicle system 1 is installed, is a vehicle with two wheels, three wheels, four wheels and the like, for example, and its driving source is an internal combustion engine such as a diesel engine and a gasoline engine, an electric motor, or a combination thereof. The electric motor operates by using power generated by a generator connected to the internal combustion engine or power discharged from a secondary cell or a fuel cell.

The vehicle system 1 includes, for example, an outside-vehicle camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automatic driving control device 100, a travel driving force output device 200, a brake device 210, and a steering device 220. These devices and equipment are connected to one another via a multiplex communication line such as a controller area network (CAN) communication line, a serial communication line, a wireless communication network and the like. The configuration illustrated in FIG. 1 is merely an example, and parts of the configuration may be omitted, or other configurations may be added.

The camera 10 is, for example, a digital camera using a solid-state imaging element such as a charge coupled device (CCD) and a complementary metal oxide semiconductor (CMOS). The camera 10 is mounted at arbitrary places on the vehicle (hereinafter, referred to as a host vehicle M) in which the vehicle system 1 is installed. In the case of capturing an image of an area in front of the host vehicle M, the camera 10 is mounted on an upper part of a front windshield, on a rear surface of a rear-view mirror, and the like. The camera 10, for example, periodically and repeatedly captures the surroundings of the host vehicle M. The camera 10 may be a stereo camera or a 360° camera.

The radar device 12 emits radio waves such as millimeter waves to the surroundings of the host vehicle M, detects radio waves (reflected waves) reflected by an object, and detects at least a position (a distance and an orientation) of the object. The radar device 12 is mounted at arbitrary places on the host vehicle M. The radar device 12 may detect the position and the speed of the object by a frequency modulated continuous wave (FM-CW) scheme.

The finder 14 is a light detection and ranging (LIDAR). The finder 14 emits light to the surroundings of the host vehicle M and measures scattered light. The finder 14 detects a distance to a target based on a time from light emission to light reception. The emitted light is a pulse-shaped laser beam, for example. The finder 14 is mounted at arbitrary places on the host vehicle M.

The object recognition device 16 performs a sensor fusion process on results of detection by some or all of the outside-vehicle camera 10, the radar device 12, and the finder 14, thereby recognizing the position, the type, the speed and the like of an object. The object recognition device 16 outputs a recognition result to the automatic driving control device 100. The object recognition device 16 may output the detection results of the outside-vehicle camera 10, the radar device 12, and the finder 14 to the automatic driving control device 100 as is. The object recognition device 16 may be omitted from the vehicle system 1.

The communication device 20 communicates with other vehicles present around the host vehicle M, a parking lot management device (to be described below), or various sensor devices by using, for example, a cellular network, a Wi-Fi network, Bluetooth (registered trademark), a dedicated short range communication (DSRC) and the like.

The HMI 30 presents various types of information to an occupant of the host vehicle M and receives an input operation of the occupant. The HMI 30 includes various display devices, speakers, buzzers, touch panels, switches, keys and the like. The HMI 30 may receive an instruction from a user by a manual operation of the user, or may receive an instruction from a user by recognizing the speech of the user.

The vehicle sensor 40 includes a vehicle speed sensor that detects the speed of the host vehicle M, an acceleration sensor that detects an acceleration, a yaw rate sensor that detects an angular velocity around a vertical axis, a direction sensor that detects the direction of the host vehicle M, and the like.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) and a flash memory. The GNSS receiver 51 identifies the position of the host vehicle M based on a signal received from a GNSS satellite. The position of the host vehicle M may be specified or supplemented by an inertial navigation system (INS) using the output of the vehicle sensor 40. The navigation HMI 52 includes a display device, a speaker, a touch panel, keys and the like. The navigation HMI 52 may be partially or entirely shared with the aforementioned HMI 30. The route determiner 53 determines, for example, a route (hereinafter, referred to as a route on a map) to a destination, which is input by an occupant using the navigation HMI 52, from the position of the host vehicle M specified by the GNSS receiver 51 (or any input position) with reference to the first map information 54. The first map information 54 is, for example, information on a road shape represented by links indicating a road and nodes connected to the links. The first map information 54 may include a road curvature, point of interest (POI) information, and the like. The route on the map is output to an MPU 60. The navigation device 50 may perform route guidance using the navigation HMI 52 based on the route on the map. The navigation device 50 may be implemented by, for example, functions of a terminal device such as a smart phone and a tablet terminal owned by the occupant. The navigation device 50 may transmit the current position and the destination to a navigation server via the communication device 20, and acquire a route equivalent to the route on the map from the navigation server.

The MPU 60 includes, for example, a recommended lane determiner 61 and stores second map information 62 in a storage device such as an HDD and a flash memory. The recommended lane determiner 61 divides the route on the map provided from the navigation device 50 into a plurality of blocks (for example, divides the route on the map every 100 m in the vehicle travel direction), and determines a recommended lane for each block with reference to the second map information 62. The recommended lane determiner 61 determines on which lane numbered from the left to travel. When there is a branch point on the route on the map, the recommended lane determiner 61 determines a recommended lane such that the host vehicle M can travel on a reasonable route for traveling to a branch destination.

The second map information 62 is more accurate map information than the first map information 54. The second map information 62 includes, for example, information on the center of a lane, information on the boundary of the lane, and the like. The second map information 62 may include road information, traffic regulation information, address information (address and postal code), facility information, telephone number information, and the like. The second map information 62 may be updated at any time by the communication device 20 communicating with another device.

The driving operator 80 includes, for example, an accelerator pedal, a brake pedal, a shift lever, steering wheel, a deformed steer, a joy stick, and other operators. The driving operator 80 is provided with a sensor for detecting an operation amount or the presence or absence of an operation, and its detection result is output to the automatic driving control device 100, or some or all of the travel driving force output device 200, the brake device 210, and the steering device 220.

The automatic driving control device 100 includes, for example, a first controller 120 and a second controller 160. Each of the first controller 120 and the second controller 160 is implemented by, for example, a hardware processor such as a central processing unit (CPU) that executes a program (software). Some or all of these components may be implemented by hardware (a circuit unit: including circuitry) such as a large scale integration (LSI), an application specific integrated circuit (ASIC), a field-programmable gate array (FPGA), and a graphics processing unit (GPU), or may be implemented by software and hardware in cooperation. The program may be stored in advance in a storage device (storage device including a non-transitory storage medium) such as an HDD and a flash memory of the automatic driving control device 100, or may be installed in the HDD and the flash memory of the automatic driving control device 100 when a detachable storage medium (non-transitory storage medium) storing the program, such as a DVD and a CD-ROM, is mounted on a drive device.

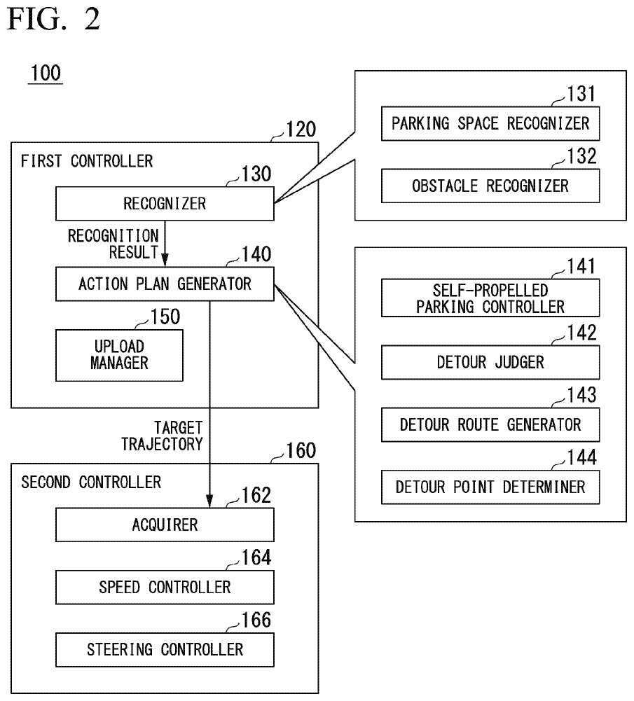

FIG. 2 is a functional configuration diagram of the first controller 120 and the second controller 160. The first controller 120 includes, for example, a recognizer 130, an action plan generator 140, and an upload manager 150. The first controller 120 performs, for example, a function based on an artificial intelligence (AI) and a function based on a predetermined model in parallel. For example, a function of “recognizing an intersection” may be implemented by performing intersection recognition by deep learning and the like and recognition based on a predetermined condition (such as a signal that can be subjected to pattern matching, road markings, and the like) in parallel, or scoring both recognition and comprehensively evaluating them. In this way, the reliability of automatic driving is ensured.

The recognizer 130 recognizes a state such as the position, speed, acceleration and the like of an object around the host vehicle M based on information input from the outside-vehicle camera 10, the radar device 12, and the finder 14 via the object recognition device 16. The position of the object is recognized, for example, as a position on absolute coordinates with a representative point (a centroid, a driving axis center, and the like) of the host vehicle M as the origin, and is used for control. The position of the object may be represented by a representative point of a centroid, a corner and the like of the object, or may be represented by an indicated area. The “state” of the object may include an acceleration, a jerk, or an “action state” (for example, whether lane change is being performed or is intended to be performed) of the object.

The recognizer 130 recognizes, for example, a lane (a travel lane) on which the host vehicle M is traveling. For example, the recognizer 130 compares a pattern (for example, an arrangement of solid lines and broken lines) of road marking lines obtained from the second map information 62 with a pattern of road marking lines around the host vehicle M, which is recognized from the image captured by the outside-vehicle camera 10, thereby recognizing the travel lane. The recognizer 130 may recognize not only the road marking lines but also a traveling road boundary (road boundary) including the road marking lines, a road shoulder, a curb, a median strip, a guardrail, and the like, thereby recognizing the travel lane. In this recognition, the position of the host vehicle M acquired from the navigation device 50 or a processing result of the INS may be added. The recognizer 130 recognizes a temporary stop line, an obstacle, a red light, a tollgate, and other road events.

When recognizing the travel lane, the recognizer 130 recognizes the position and the orientation of the host vehicle M with respect to the travel lane. The recognizer 130, for example, may recognize, as the relative position and the orientation of the host vehicle M with respect to the travel lane, a deviation of a reference point of the host vehicle M from a center of a lane and an angle formed with respect to a line connecting the center of the lane in the progress direction of the host vehicle M. Instead of this, the recognizer 130 may recognize the position and the like of the reference point of the host vehicle M with respect to any one of the side ends (the road marking line or the road boundary) of the travel lane as the relative position of the host vehicle M with respect to the travel lane.

The recognizer 130 includes, for example, a parking space recognizer 131 and an obstacle recognizer 132. The configurations of these components are activated in a self-propelled parking event to be described below. Details thereof will be described below.

The action plan generator 140 generates a target trajectory along which the host vehicle M will travel in the future automatically (independent of a driver's operation) so as to be able to travel on the recommended lane determined by the recommended lane determiner 61 in principle and further to cope with surrounding situations of the host vehicle M. The target trajectory includes a speed element, for example. For example, the target trajectory is represented as a sequence of points (trajectory points) to be reached by the host vehicle M. The trajectory point is a point that the host vehicle M is to reach every predetermined travel distance (for example, about several meters) as a road distance, and a target speed and a target acceleration at every predetermined sampling time (for example, about several tenths of a [sec]) are separately generated as a part of the target trajectory. The trajectory point may be a position that the host vehicle M is to reach at the sampling time at every predetermined sampling time. In such a case, information on the target speed and the target acceleration is represented by the interval between the trajectory points.

When generating the target trajectory, the action plan generator 140 may set events for automatic driving. The events for automatic driving include constant speed travel events, low speed following travel events, lane change events, branch events, merge events, takeover events, self-propelled parking events in which unmanned running and parking are performed in valet parking and the like, and the like. The action plan generator 140 generates the target trajectory according to an activated event.

Among the self-propelled parking events, an event in which automatic parking and automatic exit are performed according to the guidance of a parking lot management device 400 is hereinafter referred to as a self-propelled parking event. The automatic parking includes an operation of entering from an entrance of a parking lot and traveling to a parking space by automatic driving by guidance, and an operation of parking a vehicle in the parking space by the automatic driving by guidance. The automatic exit is an operation from traveling to an exit of the parking lot and exiting the parking lot to parking the vehicle in an area where an occupant boards (for example, a stop area 310 to be described below), by the automatic driving by guidance. In the automatic driving by guidance, the host vehicle M moves, for example, along a route according to guidance by the parking lot management device 400 while sensing by itself.

The parking lot management device 400 is an example of a management device that manages the parking lot, but a management target is not limited to a parking lot. For example, any facilities may be used as long as they are facilities through which a plurality of vehicles pass the same two or more points.

Hereinafter, a description will be given for an example in which, in the automatic driving by guidance, the parking lot management device 400 generates a rough travel route based on a map of the parking lot and the host vehicle M generates a target trajectory based on the travel route generated by the parking lot management device 400. The rough travel route includes, for example, a travel distance to a target of each section, a turning direction (right turn, left turn and the like), position information on the map in the parking lot, and the like, and indicates a route for traveling to a destination with reference to this information. For example, the rough travel route includes advancing along a xx passage by OO meters and turning left, turning left at a predetermined point in the parking lot map, and the like.

However, the present invention is not limited thereto. For example, in the automatic driving by guidance, the parking lot management device 400 may generate the target trajectory and the host vehicle M may travel along the target trajectory generated by the parking lot management device 400. This example will be described in a second embodiment.

The action plan generator 140 includes, for example, a self-propelled parking controller 141 that is activated when the self-propelled parking event is executed, a detour judger 142, a detour route generator 143, and a detour point determiner 144. Details of functions of these components will be described below.

The second controller 160 controls the travel driving force output device 200, the brake device 210, and the steering device 220 such that the host vehicle M passes along the target trajectory generated by the action plan generator 140 at scheduled times.

The second controller 160 includes, for example, an acquirer 162, a speed controller 164, and a steering controller 166. The acquirer 162 acquires information on the target trajectory (trajectory points) generated by the action plan generator 140 and stores the information in a memory (not illustrated). The speed controller 164 controls the travel driving force output device 200 or the brake device 210 based on a speed element associated with the target trajectory stored in the memory. The steering controller 166 controls the steering device 220 according to the degree of bending of the target trajectory stored in the memory. The processes of the speed controller 164 and the steering controller 166 are implemented by, for example, a combination of feedforward control and feedback control. As an example, the steering controller 166 performs a combination of feedforward control according to the curvature of a road in front of the host vehicle M and feedback control based on a deviation from the target trajectory.

The travel driving force output device 200 outputs a travel driving force (torque) for driving the vehicle to driving wheels. The travel driving force output device 200, for example, includes a combination of an internal combustion engine, an electric motor, a transmission and the like, and an electronic control unit (ECU) for controlling them. The ECU controls the aforementioned configuration according to information input from the second controller 160 or information input from the driving operator 80.

The brake device 210, for example, includes a brake caliper, a cylinder for transferring hydraulic pressure to the brake caliper, an electric motor for generating the hydraulic pressure in the cylinder, and a brake ECU. The brake ECU controls the electric motor according to the information input from the second controller 160 or the information input from the driving operator 80, thereby allowing a brake torque corresponding to a brake operation to be output to each wheel. The brake device 210 may have a backup mechanism for transferring the hydraulic pressure generated by an operation of the brake pedal included in the driving operator 80 to the cylinder via a master cylinder. The brake device 210 is not limited to the aforementioned configuration and may be an electronically controlled hydraulic pressure brake device that controls an actuator according to the information input from the second controller 160, thereby transferring the hydraulic pressure of the master cylinder to the cylinder.

The steering device 220, for example, includes a steering ECU and an electric motor. The electric motor, for example, changes a direction of a steering wheel by allowing a force to act on a rack and pinion mechanism. The steering ECU drives the electric motor according to the information input from the second controller 160 or the information input from the driving operator 80, thereby changing the direction of the steering wheel.

[Self-Propelled Parking Event-when Entering]

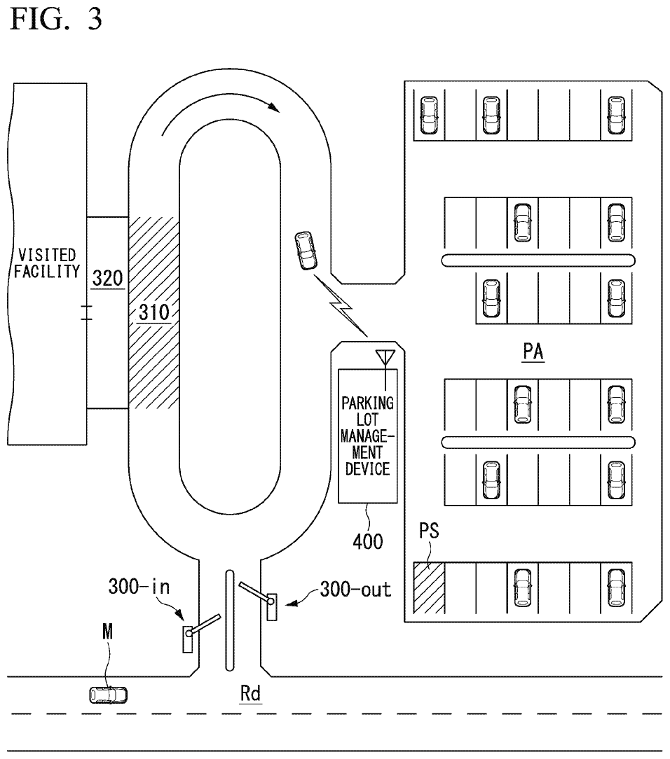

The self-propelled parking controller 141 parks the host vehicle M in the parking space based on information acquired from the parking lot management device 400 by the communication device 20, for example. FIG. 3 is a diagram schematically illustrating a scene in which the self-propelled parking event is performed. Gates 300-in and 300-out are provided on a route from a road Rd to a visited facility. The host vehicle M travels to the stop area 310 by passing through the gate 300-in by manual driving or automatic driving. The stop area 310 faces a boarding area 320 connected to the visited facility. The boarding area 320 is provided with an eave for avoiding rain and snow.

After an occupant gets off in the stop area 310, the host vehicle M starts the self-propelled parking event of performing unmanned automatic driving to move to a parking space PS in a parking lot PA. The start trigger of the self-propelled parking event may be any operation of a user or an owner of the host vehicle M through a terminal device of a user or an owner of the host vehicle M, or wireless reception of a predetermined signal from the parking lot management device 400. For example, when a request for automatic parking is received from the user of the host vehicle M using the terminal device, the parking lot management device 400 instructs the host vehicle M to start the automatic parking event based on information received from the terminal device, and performs guidance for performing the automatic parking. The present invention is not limited thereto and a request for automatic parking may be received using the HMI 30. For example, when the host vehicle M receives a request for automatic parking from the user by using the HMI 30, the host vehicle M starts the automatic parking event and the parking lot management device 400 performs guidance for performing the automatic parking.

When starting the self-propelled parking event, the self-propelled parking controller 141 controls the communication device 20 such that a parking request is transmitted to the parking lot management device 400. Then, the host vehicle M moves from the stop area 310 to the parking lot PA while sensing by itself according to the guidance of the parking lot management device 400. For example, a route to a target parking position is instructed by the parking lot management device 400, and the host vehicle M travels along the route instructed by the parking lot management device 400 while sensing by itself.

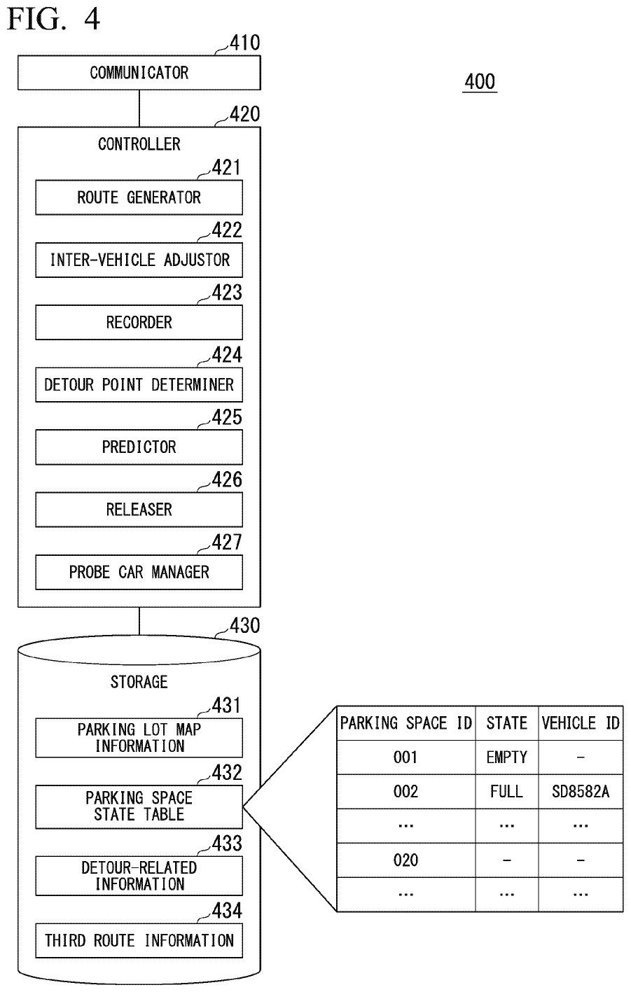

FIG. 4 is a diagram illustrating an example of the configuration of the parking lot management device 400. The parking lot management device 400 includes, for example, a communicator 410, a controller 420, and a storage 430. The storage 430 stores information such as parking lot map information 431, a parking space state table 432, detour-related information 433, and third route information 434.

The communicator 410 wirelessly communicates with the host vehicle M and other vehicles. The controller 420 includes, for example, a route generator 421, an inter-vehicle adjustor 422, a recorder 423, a detour point determiner 424, a predictor 425, a releaser 426, and a probe car manager 427. Details of the recorder 423, the detour point determiner 424, the predictor 425, the releaser 426, and the probe car manager 427 will be described below.

The route generator 421 guides the vehicle to the parking space PS based on information acquired by the communicator 410 and the information stored in the storage 430. The parking lot map information 431 is information that geometrically represents the structure of the parking lot PA. The parking lot map information 431 includes coordinates for each parking space PS. In the parking space state table 432, a state, which indicates whether each parking space PS is empty or full (parked), and a vehicle ID, which is identification information of a vehicle parked when each parking space PS is full, are correlated with a parking space ID that is identification information of each parking space PS.

When the communicator 410 receives a parking request from a vehicle, the route generator 421 extracts a parking space PS in an empty state with reference to the parking space state table 432, acquires a position of the extracted parking space PS from the parking lot map information 431, generates a preferred route to the acquired position of the parking space PS, and transmits information indicating the generated route to the vehicle by using the communicator 410. The route generated by the route generator 421 (the parking lot management device 400) is hereinafter referred to as a first route.

The inter-vehicle adjustor 422 instructs a specific vehicle to stop or slow down, as necessary, based on a positional relation between a plurality of vehicles such that the vehicles do not advance to the same position at the same time.

In the vehicle having received the first route (hereinafter, referred to as the host vehicle M), the self-propelled parking controller 141 generates a target trajectory based on the first route. When approaching the target parking space PS, the parking space recognizer 131 recognizes a parking frame line and the like that partition off the parking space PS, recognizes a detailed position of the parking space PS, and provides the recognized position to the self-propelled parking controller 141. The self-propelled parking controller 141 receives the position, corrects the target trajectory, and parks the host vehicle M in the parking space PS.

[Self-Propelled Parking Event-when Leaving]

The self-propelled parking controller 141 and the communication device 20 maintain an operation state even while the host vehicle M is parked. For example, when a pick-up request is received from the terminal device of the user, the route generator 421 of the parking lot management device 400 generates the first route from the parking space PS to the stop area 310, and transmits the first route to the host vehicle M. When the first route is received, the self-propelled parking controller 141 of the host vehicle M activates the system of the host vehicle M and moves the host vehicle M to the stop area 310 along the first route. At this time, similarly to when entering, the inter-vehicle adjustor 422 of the parking lot management device 400 instructs a specific vehicle to stop or slow down, as necessary, based on a positional relation among a plurality of vehicles such that the vehicles do not advance to the same position at the same time. When the host vehicle M is moved to the stop area 310 and an occupant gets on the host vehicle M, the self-propelled parking controller 141 stops operating, and then manual driving or automatic driving by a separate function unit is started.

[When Finding Obstacle]

The obstacle recognizer 132 recognizes an object, which exists on a passage among objects existing in front of the host vehicle M, as an obstacle. The obstacle includes, for example, a fallen object, another stopped vehicle, a shopping cart, and the like. On the other hand, the obstacle recognizer 132 does not recognize a part of a building in a parking lot, a vehicle parked in a marking line of a parking space, and the like as an obstacle even though these objects are present in front of the host vehicle M.

The obstacle recognizer 132 recognizes the size of the recognized obstacle. For example, based on an image obtained by capturing the obstacle, the obstacle recognizer 132 uses the width of the passage or the size of a pillar in the parking lot PA as a reference and derives the lengths and the like of the obstacle in the height direction, the vehicle width direction, and the depth direction with respect to the reference. The obstacle recognizer 132 recognizes the type of the obstacle. For example, the obstacle recognizer 132 collates pattern data of each item registered in advance and image data obtained by imaging the obstacle and recognizes a matching item as the type of the obstacle. The obstacle recognizer 132 recognizes the position of the recognized obstacle. For example, the obstacle recognizer 132 may recognize, as the position of the obstacle, absolute coordinates of the obstacle or coordinates of an obstacle in the map of the parking lot.

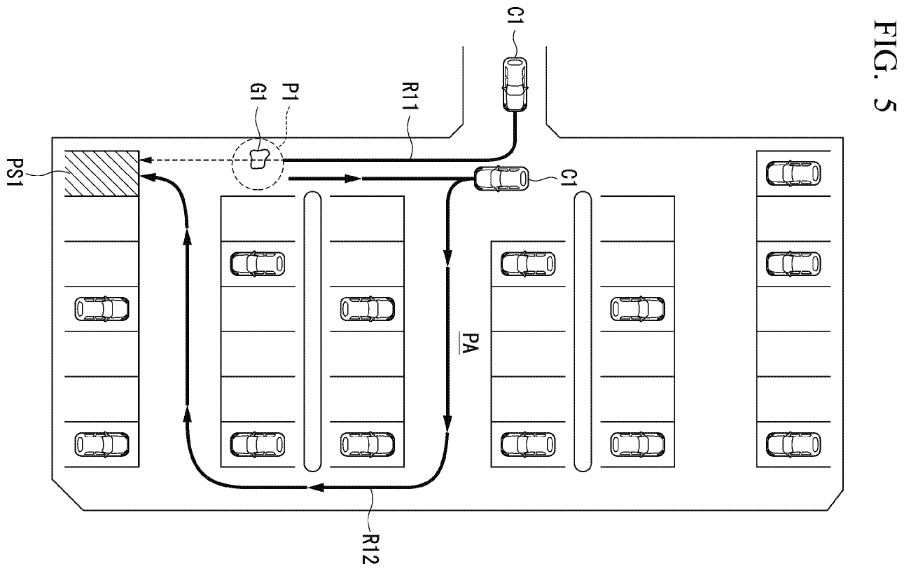

FIG. 5 is a diagram schematically illustrating an example of a travel route when an obstacle exists on a passage. Hereinafter, a description will be given for a travel route on which a first vehicle C1, which is an example of the host vehicle M, parks in a parking space PS1. The first route of the first vehicle C1 generated by the parking lot management device 400 is, for example, a route R11 from the entrance of the parking lot PA to the parking space PS1 as the shortest distance. The first vehicle C1 recognizes an obstacle G1 while traveling on the route R11 while sensing by itself. When recognizing the obstacle G1, the first vehicle C1 generates a detour route R12 for traveling toward the parking space PS1 without passing through a passage where the obstacle G1 exists while sensing by itself, and travels along the generated route. The first vehicle C1 generates information indicating a route on which the first vehicle C1 has actually traveled (hereinafter, referred to as a second route) and transmits the information to the parking lot management device 400. For example, the first vehicle C1 returns back from the passage where the obstacle G1 exists, generates the detour route R12 toward the parking space PS1 based on the recognition result of the recognizer 130, and generates a target trajectory for traveling on the generated detour route R12. The host vehicle M transmits the generated target trajectory to the parking lot management device 400 as the second route.

The detour judger 142 determines whether to make a detour based on the recognition result of the obstacle recognizer 132. For example, when the size of the recognized obstacle G1 is larger than a reference size (for example, when the length in the vehicle direction is equal to or more than a reference length), the detour judger 142 determines to make a detour. On the other hand, when the size of the recognized obstacle is smaller than the reference size or when the type of the recognized obstacle is a fallen leaf, a plastic bag and the like and the host vehicle M can travel on the obstacle, the detour judger 142 may determine not to make a detour.

The detour route generator 143 generates the detour route R12 based on the recognition result of the recognizer 130. For example, the detour route generator 143 generates the detour route R12 that returns back to a node connected to another passage, turns counterclockwise as viewed from the travel direction of the first vehicle C1, and heads toward the parking space PS1. In the parking lot PA, parking spaces are regularly partitioned and passages are straight in most cases. The example illustrated in FIG. 5 is also the same, and when the first vehicle C1 returns back and turns left, and then turns right twice, the parking space PS1 appears on the left side in the travel direction. In this way, the detour route generator 143 may store the movement of the vehicle for generating the detour route as a pattern, and generate the detour route toward a passage where the parking space PS1 appears according to the pattern. The detour route generator 143 may determine the location of the target parking space PS1 based on the coordinates, the parking space ID and the like of the parking space PS1 included in the first route R11 generated by the parking lot management device 400, or receive the location of the target parking space PS1 as a response for a request to the parking lot management device 400. When arriving near the parking space PS1, the detour route generator 143 parks the host vehicle M in the recognized parking space PS1.

The detour point determiner 144 determines a location where the host vehicle M makes a detour and does not pass (hereinafter, referred to as a detour point). For example, the detour point determiner 144 may determine, as the detour point, a start point of the second route, which is an interruption point of traveling along the first route generated by the parking lot management device 400 and different from the first route. In the example of FIG. 5, the detour point determiner 144 determines a point “P1” as the detour point. The present invention is not limited thereto and the detour point determiner 144 may determine, as the detour point, a location where an obstacle has been recognized by the obstacle recognizer 132.

The upload manager 150 uploads various types of information acquired in the host vehicle M to the parking lot management device 400. For example, the upload manager 150 generates obstacle information based on the recognition result of the obstacle recognizer 132, and transmits the generated obstacle information to the parking lot management device 400 by using the communication device 20. The upload manager 150 transmits information indicating the determination result of the detour judger 142 to the parking lot management device 400 by using the communication device 20. The upload manager 150 transmits information indicating at least a part of the second route generated by the detour route generator 143 to the parking lot management device 400 by using the communication device 20. The upload manager 150 transmits the target trajectory generated by the self-propelled parking controller 141 based on the first route and the target trajectory generated by the self-propelled parking controller 141 based on the second route to the parking lot management device 400 by using the communication device 20. The upload manager 150 transmits information indicating the detour point determined by the detour point determiner 144 to the parking lot management device 400 by using the communication device 20.

On the other hand, in the parking lot management device 400, the recorder 423 stores, in the storage 430, information received from the host vehicle M using the communicator 410. For example, the recorder 423 updates the detour-related information 433 of the storage 430 based on the information received from the host vehicle M.

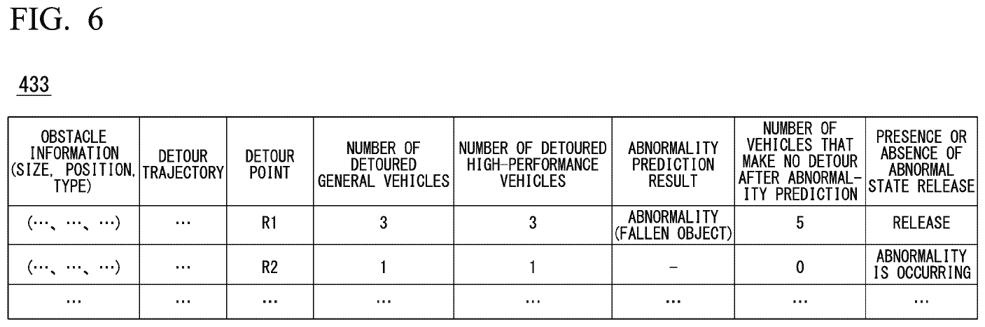

FIG. 6 is a diagram illustrating an example of the detour-related information 433. The detour-related information 433 includes, for example, information in which a detour trajectory, a detour point, the number of detoured general vehicles, the number of detoured high-performance vehicles, an abnormality prediction result, the number of vehicles that make no detour after abnormality prediction, and the presence or absence of abnormal state release are correlated with the obstacle information. The obstacle information includes, for example, information indicating the size, position, type and the like of an obstacle recognized by each vehicle. The detour trajectory is, for example, the target trajectory of the second route on which the host vehicle M has actually traveled. The detour point is information indicating the position of the detour point determined by the vehicle or the parking lot management device 400.

The obstacle information, the detour trajectory, and the detour point may be stored in the detour-related information 433 of each vehicle having acquired each information, or may be updated by giving a priority to a high-performance vehicle as compared to a general vehicle. For example, when each information is already stored, the recorder 423 compares outside world detection performance of a vehicle having acquired each information registered in the detour-related information 433 at the present time with outside world detection performance of a vehicle having acquired each information to be registered from this, and when the latter outside world detection performance is high, the recorder 423 updates each information of the detour-related information 433 with information acquired by the vehicle with the higher outside world detection performance.

The number of detoured general vehicles is the number of general vehicles that have made a detour around the same detour point after the detour point is determined (in other words, after an obstacle is found and the vehicle makes a detour, the same applies below). The number of detoured high-performance vehicles is the number of high-performance vehicles that have made a detour around the same detour point after the detour point is determined. The high-performance vehicles are vehicles having higher outside world detection performance than general vehicles. The outside world detection performance includes, for example, the accuracy and the like of recognizing the periphery of the vehicle. For example, information transmitted from the high-performance vehicle includes information indicating that a vehicle having acquired the information is a high-performance vehicle.

The abnormality prediction result is a prediction result predicted by the predictor 425. The number of vehicles that make no detour after abnormality prediction is the number of vehicles that have passed through the same detour point after the predictor 425 predicts that some abnormality has occurred in the parking lot PA. The presence or absence of abnormal state release is information indicating whether an abnormality predicted by the predictor 425 has been released by the releaser 426.

When no information indicating the detour point is received from the host vehicle M, the detour point determiner 424 may determine the detour point in the same manner as in the detour point determiner 144. For example, the detour point determiner 424 determines, as the detour point, a point at which the traveling along the first route generated by the route generator 421 is interrupted and at which the host vehicle M starts traveling on the second route different from the first route. The detour point determiner 144 may compare the first route generated by the route generator 421 with the second route received from the host vehicle M, and may determine a point on the first route and not on the second route as the detour point in the comparison result. When the information indicating the detour point is received from the host vehicle M, the detour point determiner 424 may determine, as the detour point, a point included in the information, or may determine, as the detour point, the position of the obstacle included in the obstacle information received from the host vehicle M.

[Abnormality Prediction]

The predictor 425 predicts that some abnormality has occurred in the parking lot PA when the number of vehicles in which the first route generated by the route generator 421 and the actually traveled second route are different from each other exceeds a predetermined number. For example, the predictor 425 refers to the detour-related information 433, and predicts that some abnormality has occurred in the parking lot PA when the number of detoured general vehicles exceeds a threshold th1. The predictor 425 refers to the detour-related information 433, and may predict that some abnormality has occurred in the parking lot PA when the number of detoured high-performance vehicles exceeds a threshold th2 (th2<th1). For example, in the case of general vehicles, when five or more vehicles have made a detour around the detour point, it is predicted that some abnormality has occurred in the parking lot PA, and in the case of high-performance vehicles, when any one has made a detour around the detour point, it is predicted that some abnormality has occurred in the parking lot PA. When it is predicted that some abnormality has occurred in the parking lot PA, the predictor 425 writes, in the detour-related information 433, information indicating that an abnormality has been predicted in “the abnormality prediction result” correlated with the detour point predicted to have some abnormality.

The predictor 425 may predict that an abnormality has occurred only in a passage including the detour point or may predict that an abnormality has occurred in the entire parking lot PA, according to the type, size, position and the like of the obstacle. For example, when the type of the obstacle is a lump of snow fallen from the vehicle or when the position of the obstacle is near the end of the parking lot PA, the predictor 425 predicts that an abnormality has occurred in the passage including the detour point. For example, when the type of the obstacle is a building material predicted as a part of the building material of the parking lot PA, when the size of the obstacle is larger than a reference value by a predetermined number or more, or when the obstacle is in a position that blocks the entrance of the parking lot, the predictor 425 predicts that an abnormality has occurred in the entire parking lot PA.

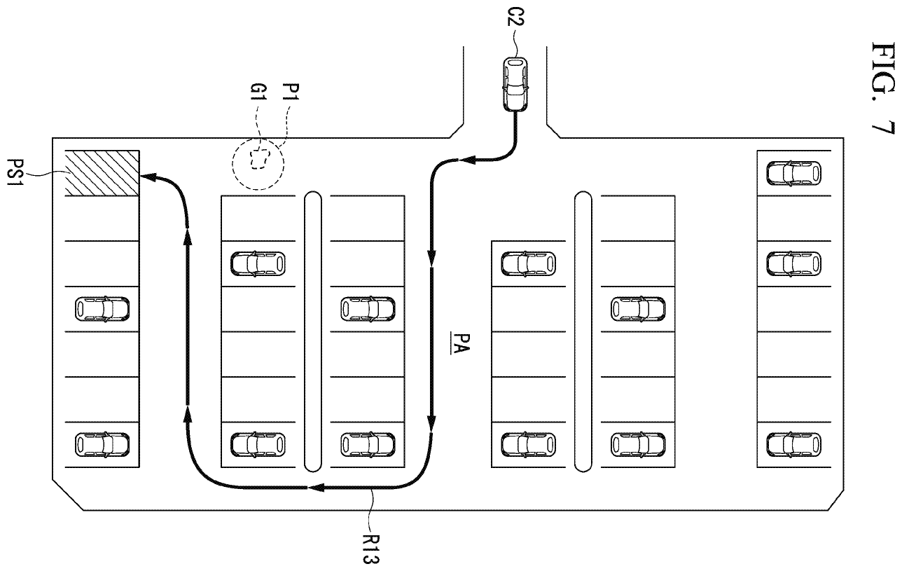

When the predictor 425 predicts that an abnormality has occurred, the route generator 421 generates a route of a subsequent vehicle based on a detour route on which the vehicle has actually traveled. For example, when a first route of the subsequent vehicle is generated and the generated first route of the subsequent vehicle partially overlaps the first route of the vehicle that has actually traveled on the detour route, the route generator 421 corrects the first route of the subsequent vehicle based on the actually traveled detour route (second route). When the detour point is included in the first route of the subsequent vehicle, the route generator 421 corrects the first route of the subsequent vehicle based on the actually traveled detour route (second route). Hereinafter, details will be described with reference to FIG. 7.

FIG. 7 is a diagram schematically illustrating an example of a travel route after the occurrence of an obstacle is predicted. Hereinafter, a description will be given for a travel route on which a second vehicle C2, which is an example of the host vehicle M, parks in the parking space PS1. The first route of the second vehicle C2 generated by the parking lot management device 400 is, for example, a route R13 from the entrance of the parking lot PA to the parking space PS1 via the route detoured by the first vehicle C1. The second vehicle C2 determines whether the obstacle G1 still exists at the detour point P1 based on the recognition result of the recognizer 130 while traveling on the route R13. For example, when the recognizer 130 recognizes an obstacle existing at the detour point P1, the second vehicle C2 transmits the fact to the parking lot management device 400 and travels on the route R13 that makes a detour around the detour point P1.

The route R13 is an example of a third route generated by the route generator 421. When the first route of the first vehicle C1 is different from the second route on which the first vehicle C1 has actually traveled, the route generator 421 generates the third route based on the second route with respect to the second vehicle C2 that passes through the same two or more points (for example, the entrance of the parking lot PA and an entrance-side passage and an exit-side passage) after the first vehicle C1. For example, when the predictor 425 predicts that some abnormality has occurred in the parking lot PA, the route generator 421 generates the third route including an actual travel route (detour trajectory) of the second vehicle C2 that has made a detour around the detour point, with respect to the second vehicle C2 that passes through the detour point predicted to have an abnormality. For example, the route generator 421 generates the route R11 that does not consider the detour point, corrects the route R11 based on the detour trajectory included in the route R12, and sets the corrected route as the route R13. The present invention is not limited thereto and the route generator 421 may generate a route connecting the first route R11 and the second route R12 at the shortest distance as the route R13, except for parts of the route R11 and the route R12 that turned back toward the detour point P1, in the first route R11 and the second route R12. When there are a plurality of information on an actually detoured route, the route generator 421 may generate the third route based on the second route on which a vehicle with the highest outside word detection capability has traveled from the information.

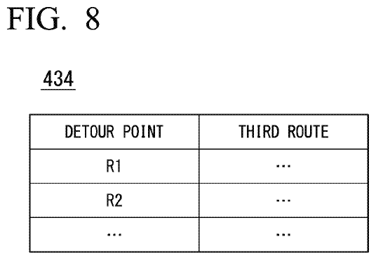

The route generator 421 stores information indicating the generated third route in the third route information 434 of the storage 430 in correlation with the detour point. FIG. 8 is a diagram illustrating an example of the third route information 434. The third route information 434 is, for example, information in which the third route is correlated with the detour point. The detour point is information indicating the position of the detour point. The third route is, for example, information indicating a rough route or a target trajectory of the third route.

By so doing, the parking lot management device 400 can generate a detour route based on a route on which the vehicle has actually traveled, that is, a route on which detour has been successful, with respect to the detour point detoured by the vehicle. Thus, a subsequent vehicle can travel by making a detour around the obstacle G2. Even when the outside world recognition performance of the subsequent vehicle is low and it is not possible to recognize an obstacle, the obstacle can be detoured by traveling along the detour route generated by the parking lot management device 400.

When both the second route on which the general vehicle has traveled and the second route on which the high-performance vehicle has traveled are stored in the detour-related information 433 as the second route that has actually made a detour around the same detour point, the route generator 421 generates the third route based on the second route on which the high-performance vehicle has traveled. When there is a second route on which a probe car has actually traveled, the route generator 421 generates the third route based on the second route on which the probe car has actually traveled.

On the other hand, even when the recognizer 130 recognizes that there is no obstacle at the detour point P1, the second vehicle C2 transmits the fact to the parking lot management device 400. When the notification indicating the recognition of the absence of the obstacle is received from the vehicle, the parking lot management device 400 determines that the predicted abnormality has been resolved, and returns a travel route to be generated to the original. For example, when the predicted abnormality has been resolved, the route generator 421 generates a route in the same manner as when the occurrence of an abnormality is not predicted. That is, the route generator 421 generates a route by a method that does not refer to the actually traveled second route or the detour point. Hereinafter, details will be described.

[Abnormality Resolution]

The releaser 426 determines whether the abnormal state predicted by the predictor 425 has been resolved. For example, when it is recognized that there is no obstacle at the detour point predicted by the predictor 425 to have some abnormality, the releaser 426 determines that the abnormal state has been resolved. Then, when it is determined that the abnormal state predicted for the detour point has been resolved, the releaser 426 rewrites the “presence or absence of abnormal state release” of the detour-related information 433 to “release”.

When the vehicle has passed the detour point predicted by the predictor 425 to have some abnormality after the abnormality is predicted, the releaser 426 mat determine that the abnormal state has been released. For example, based on the second route (actually traveled route) received from each vehicle by using the communicator 410, the releaser 426 refers to the detour-related information 433 and determines whether the detour point predicted by the predictor 425 to have some abnormality is included in the received second route. When the detour point is included in the received second route, the releaser 426 determines that the abnormal state predicted for the detour point has been resolved. As described above, when at least one has passed through the detour point predicted to have an abnormality, the releaser 426 may determine that the abnormal state has been resolved.

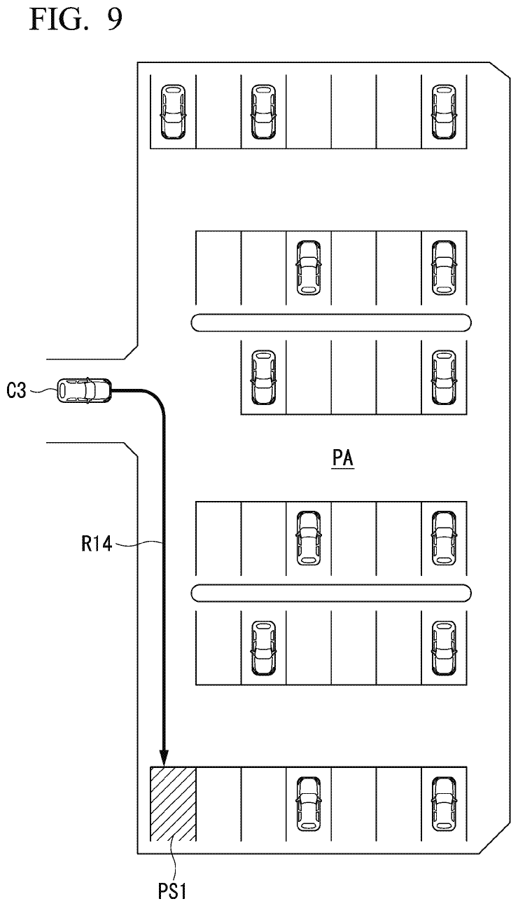

FIG. 9 is a diagram schematically illustrating an example of a travel route immediately after the abnormal state predicted for the detour point is resolved. Hereinafter, a description will be given for a travel route on which a third vehicle C3, which is an example of the host vehicle M, parks in the parking space PS1. The first route of the third vehicle C3 generated by the parking lot management device 400 is, for example, a route R14 from the entrance of the parking lot PA to the parking space PS1 at the shortest distance.

By so doing, after an obstacle is removed, the parking lot management device 400 can generate a route that makes no detour as before and guide the vehicle.

[Flowchart]

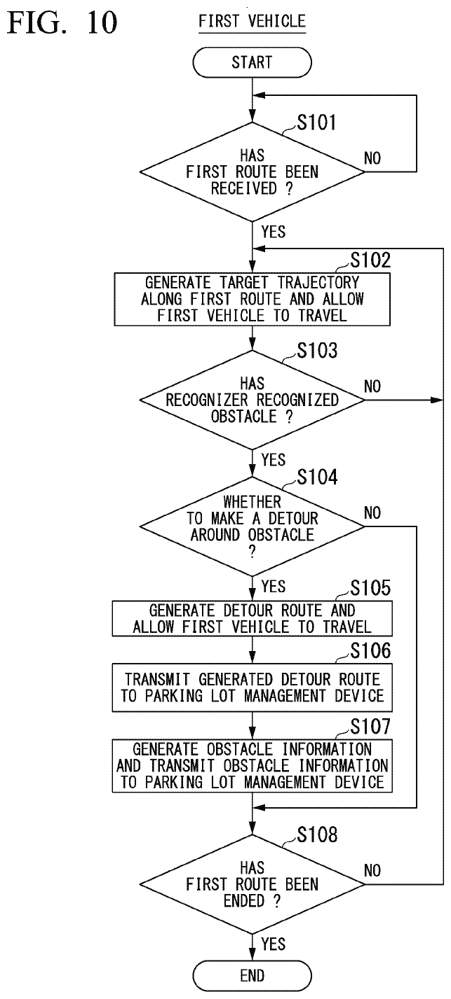

FIG. 10 is a flowchart illustrating an example of a process performed in the vehicle system 1 of the first vehicle C1. First, the self-propelled parking controller 141 determines whether the first route has been received from the parking lot management device 400 (step S101). When the first route has been received, the self-propelled parking controller 141 generates a target trajectory along the first route and allows the first vehicle C1 to travel on the generated target trajectory (step S102).

Next, the obstacle recognizer 132 determines whether the presence of an obstacle has been recognized (step S103). When the presence of the obstacle has not been recognized, the procedure returns to step S102 and repeats the process. On the other hand, when the presence of the obstacle has been recognized by the obstacle recognizer 132 in step S103, the detour judger 142 determines whether to make a detour around the obstacle based on the recognition result of the obstacle recognizer 132 (step S104). When it is determined not to make a detour, the procedure returns to step S108. On the other hand, when it is determined to make a detour in step S104, the detour route generator 143 generates a target trajectory of a detour route based on the recognition result of the recognizer 130, and allows the first vehicle C1 to travel on the generated target trajectory of the detour route (step S105). Then, the detour route generator 143 transmits information indicating the generated target trajectory of the detour route to the parking lot management device 400 by using the communication device 20 (step S106). The upload manager 150 generates obstacle information based on the recognition result of the obstacle recognizer 132, and transmits the generated obstacle information to the parking lot management device 400 by using the communication device 20 (step S107).

Next, the self-propelled parking controller 141 determines whether the travel of the first route has been ended (step S108). When the travel of the first route has not been ended, the self-propelled parking controller 141 returns to step S102 and repeats the process.

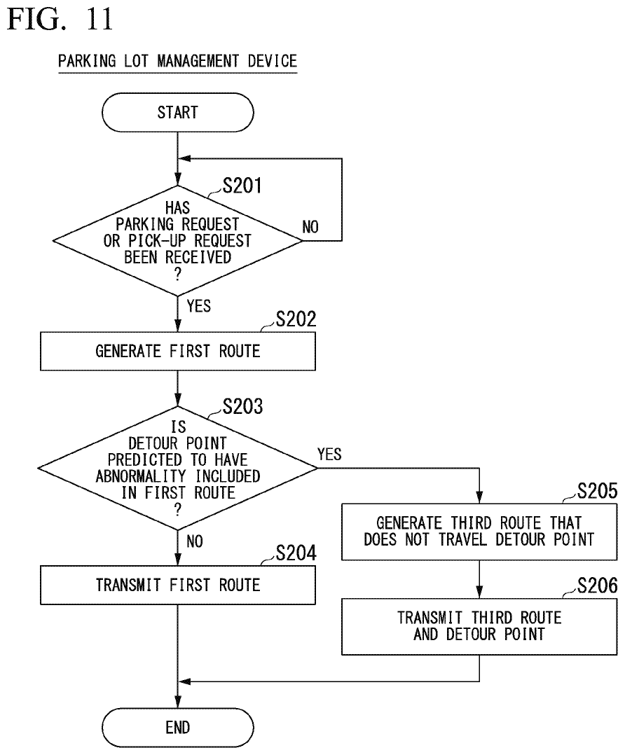

FIG. 11 is a flowchart illustrating an example of the route generation process performed in the parking lot management device 400. First, the route generator 421 determines whether a parking request or a pick-up request has been received (step S201). When the parking request or the pick-up request has been received, the route generator 421 generates the first route (step S202). Next, the route generator 421 refers to the detour-related information 433 and determines whether the detour point predicted by the predictor 425 to have some abnormality is included in the first route generated in step S202 (step S203). When the detour point predicted to have an abnormality is not included in the first route generated in step S202, the route generator 421 transmits the first route to a vehicle corresponding to the parking request or the pick-up request by using the communicator 410 (step S204).

On the other hand, in the determination in step S203, when the detour point predicted to have an abnormality is included in the first route generated in step S202, the route generator 421 refers to the detour-related information 433 and generates the third route that does not travel the detour point predicted to have an abnormality (step S205). Then, the route generator 421 transmits the third route and information indicating the detour point in step S205 to the vehicle corresponding to the parking request or the pick-up request by using the communicator 410 (step S206).

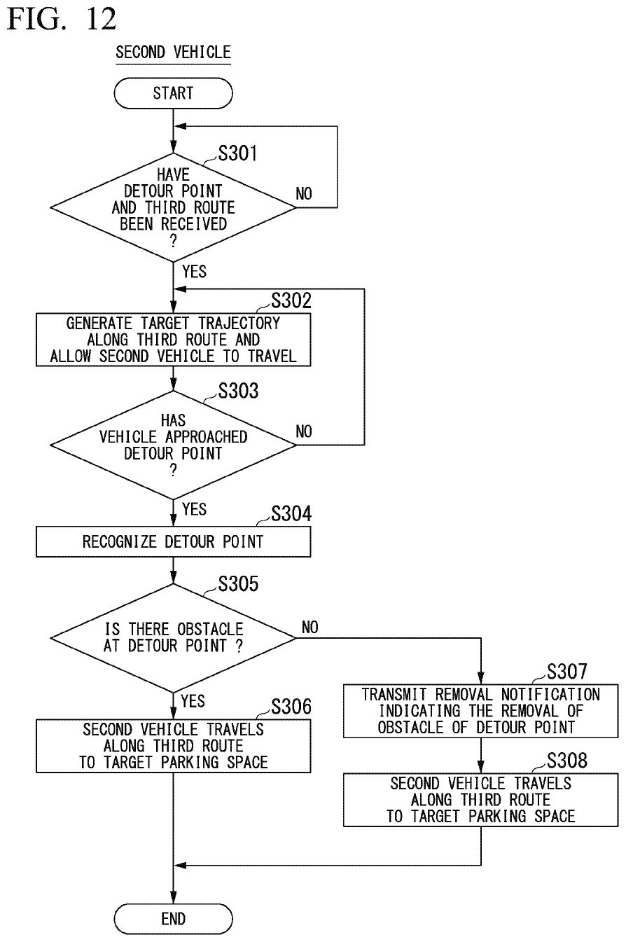

FIG. 12 is a flowchart illustrating an example of a process performed in the vehicle system 1 of the second vehicle C2. First, the self-propelled parking controller 141 determines whether the detour point and the third route have been received from the parking lot management device 400 (step S301). When the detour point and the third route have been received, the self-propelled parking controller 141 generates a target trajectory along the third route and allows the second vehicle C2 to travel on the generated target trajectory (step S302). Then, the self-propelled parking controller 141 determines whether the second vehicle C2 has approached the detour point (step S303). The self-propelled parking controller 141 returns to step S302 and repeats the process until the second vehicle C2 approaches the detour point.

When it is determined in step S303 that the second vehicle C2 has approached the detour point, the obstacle recognizer 132 recognizes the detour point (step S304). Based on the recognition result, the obstacle recognizer 132 determines whether the presence of an obstacle at the detour point has been recognized (step S305). When the presence of the obstacle at the detour point has been recognized, the self-propelled parking controller 141 allows the second vehicle C2 to travel along the third route to a target parking space (step S306).

On the other hand, when the absence of an obstacle at the detour point has been recognized, the upload manager 150 transmits a removal notification indicating that the obstacle of the detour point has been removed to the parking lot management device 400 by using the communication device 20 (step S307). Then, the self-propelled parking controller 141 allows the second vehicle C2 to travel along the third route to the target parking space (step S308). In step S308, the self-propelled parking controller 141 may generate a target trajectory for traveling on the detour point where it has been recognized that there is no obstacle, and allow the second vehicle C2 to travel to the target parking space.

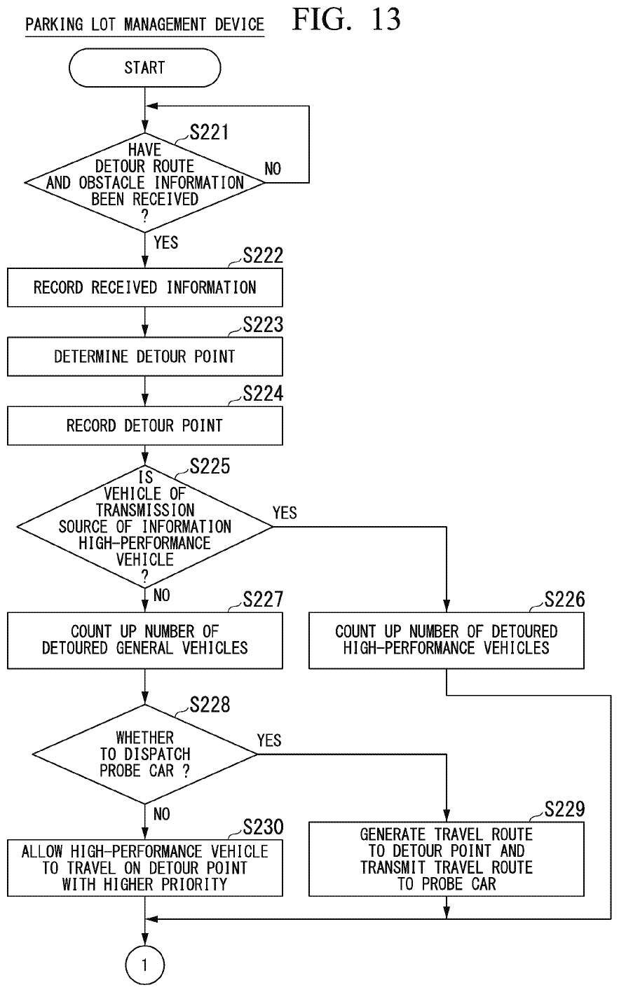

FIG. 13 is a flowchart illustrating an example of the detour-related process performed in the parking lot management device 400. First, the controller 420 determines whether the information indicating the target trajectory of the detour route and the obstacle information have been received from the vehicle by using the communicator 410 (step S221). When the information indicating the target trajectory of the detour route and the obstacle information have been received from the vehicle, the recorder 423 updates the detour-related information 433 based on the information received from the vehicle by using the communicator 410 (step S222). Next, the detour point determiner 424 determines a detour point based on the information received from the vehicle by using the communicator 410 (step S223). The recorder 423 records the detour point, which is determined by the detour point determiner 424, in the detour-related information 433 (step S224).

Next, the recorder 423 determines whether a transmission source of the obstacle information and the like received in step S221 is a high-performance vehicle (step S225). For example, when not only the obstacle information and the like but also information, which indicates that the vehicle having acquired the obstacle information is a high-performance vehicle, are received, the recorder 423 determines that the vehicle, which is the transmission source of the information, is a high-performance vehicle. When it is determined in step S225 that the vehicle, which is the transmission source of the information, is a high-performance vehicle, the recorder 423 counts up “the number of detoured high-performance vehicles” included in the detour-related information 433 (step S226).

On the other hand, when it is determined in step S225 that the vehicle, which is the transmission source of the information, is not a high-performance vehicle, the recorder 423 counts up “the number of detoured general vehicles” included in the detour-related information 433 (step S227). Then, the probe car manager 427 determines whether to dispatch a probe car (step S228). For example, the probe car manager 427 stores information on a probe car that can be dispatched in the storage 430 and refers to the stored information, and when a probe car that can be dispatched exists in the parking lot PA, the probe car manager 427 determines to dispatch the probe car. The present invention is not limited thereto and the probe car manager 427 may communicate with the probe car by using the communicator 410, check whether the probe car can be dispatched, and determine to dispatch the probe car when receiving the fact that dispatch is possible from the probe car. When the probe car manager 427 determines to dispatch the probe car, the route generator 421 generates a route to the detour point recorded in step S224 and transmits the route to the probe car by using the communicator 410 (step S229).

The probe car is, for example, a management vehicle prepared in the parking lot PA. Preferably, the probe car is a high-performance vehicle in order to check more accurately the current state of a location where an abnormality has occurred. When the current state of the location where an abnormality has occurred is checked or when an obstacle can be collected, the probe car may have a configuration for collecting the obstacle.

On the other hand, when the probe car manager 427 determines not to dispatch the probe car in step S228, the inter-vehicle adjustor 422 allows a high-performance vehicle to travel on the detour point with higher priority than a general vehicle (step S230). For example, the inter-vehicle adjustor 422 instructs a general vehicle to stop or slow down such that a high-performance vehicle travels on the detour point, which is determined in step S223 on the vehicle route, earlier than a general vehicle among vehicles that travel on the detour point.

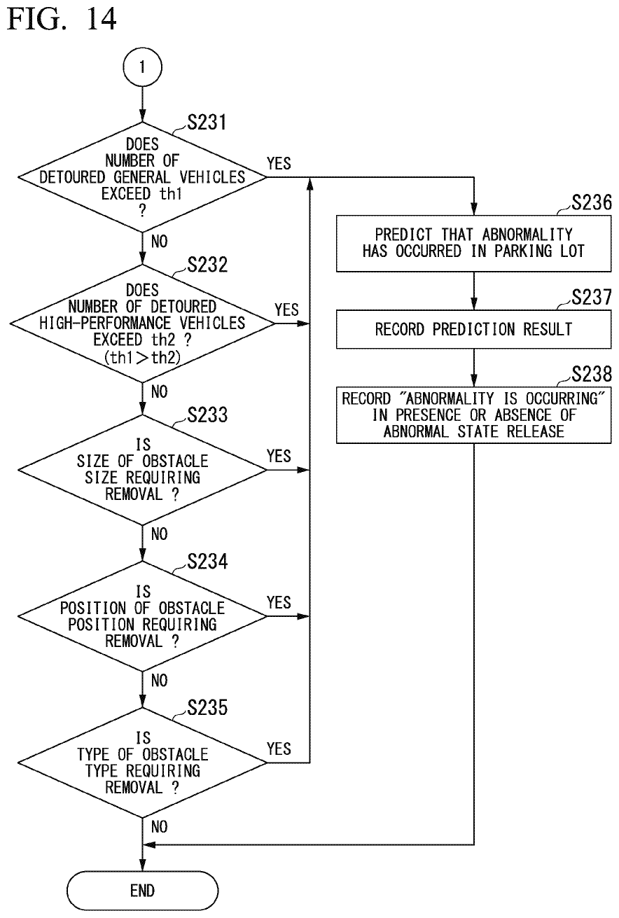

FIG. 14 is a flowchart illustrating a continuation of the process of FIG. 13. The predictor 425 refers to the detour-related information 433 and determines whether “the number of detoured general vehicles” exceeds a threshold th1 (step S231). When “the number of detoured general vehicles” does not exceed the threshold th1, the predictor 425 refers to the detour-related information 433 and determines whether “the number of detoured high-performance vehicles” exceeds a threshold th2 (step S232).

When “the number of detoured high-performance vehicles” does not exceed the threshold th2, the predictor 425 refers to the obstacle information of the detour-related information 433 and determines whether the size of the obstacle is a size requiring removal (step S233). When the size of the obstacle is larger than a predetermined size, the predictor 425 determines that the size of the obstacle is a size requiring removal.

When the size of the obstacle is not a size requiring removal, the predictor 425 refers to the obstacle information of the detour-related information 433 and determines whether the position of the obstacle is a position requiring removal (step S234). When the position of the obstacle is a position where many vehicles travel, such as the entrance of the parking lot PA, the predictor 425 determines that the position of the obstacle is a position requiring removal.

When the position of the obstacle is not a position requiring removal, the predictor 425 refers to the obstacle information of the detour-related information 433 and determines whether the type of the obstacle is a type requiring removal (step S235). When the type of the obstacle is highly urgent, for example, when the type of the obstacle is a person, an animal, a large fallen object, a burning object and the like, the predictor 425 determines that the type of the obstacle is a type that requiring removal. When the type of the obstacle is not a type requiring removal, the predictor 425 ends the process.

On the other hand, when an affirmative determination is made in any one of steps S231 to S235, the predictor 425 predicts that some abnormality has occurred at the detour point registered in step S224 (step S236). Then, the predictor 425 writes information, which indicates the abnormality has been predicted, in “the abnormality prediction result” of the detour-related information 433, which is correlated with the detour point predicted to have some abnormality (step S237). Next, the predictor 425 records “the presence or absence of abnormal state release” of the detour-related information 433 as “abnormality is occurring” (step S238).

Although not illustrated in the drawing, as described above, even when the predictor 425 predicts that an abnormality has occurred in the entire parking lot PA, the process may be performed after step S236.

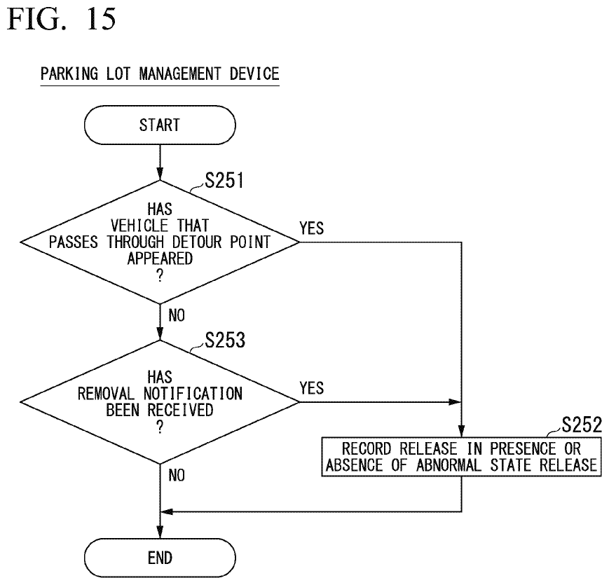

FIG. 15 is a flowchart illustrating an example of the release process performed in the parking lot management device 400. The releaser 426 determines the appearance of the vehicle that passes through the detour point predicted by the predictor 425 to have some abnormality after the abnormality is predicted (step S251). When the vehicle that passes through the detour point after the abnormality is predicted has appeared, the releaser 426 determines that the abnormal state predicted by the predictor 425 has been resolved and rewrites “the presence or absence of abnormal state release” of the detour-related information 433 to “release” (step S252).

On the other hand, in the determination of step S251, when there is no vehicle that passes through the detour point after the abnormality is predicted, the releaser 426 determines whether the removal notification indicating the removal of the obstacle of the detour point has been received from the vehicle by using the communicator 410 (step S253). When the removal notification indicating the removal of the obstacle of the detour point has been received, the procedure proceeds to step S252.

### Summary of Embodiment

As described above, the parking lot management device 400 of the present embodiment is a management device that guides a vehicle capable of automatically traveling, and includes a generator that generates a route for guiding the vehicle, and a communicator that transmits information on the generated route to the vehicle and receives information on a route on which the vehicle has actually traveled from the vehicle, wherein, when the first route generated as a route of the first vehicle is different from the second route on which the first vehicle has actually traveled, the generator generates the third route based on the second route with respect to the second vehicle that passes through the same two or more points as the first vehicle after the first vehicle, and the communicator transmits information on the third route to the second vehicle. Consequently, it is possible to smoothly guide an automatically driven vehicle to a destination in valet parking.

### Second Embodiment

The aforementioned first embodiment has described an example in which the parking lot management device 400 generates a rough travel route based on the map in the parking lot and the host vehicle M generates the target trajectory based on the travel route generated by the parking lot management device 400. In the second embodiment, a description will be given for an example in which the parking lot management device 400 generates the target trajectory and the host vehicle M travels along the target trajectory generated by the parking lot management device 400. Except for this point, a detailed description of the same content as in the first embodiment will be omitted and different content will be described below. The following process is performed by providing the parking lot management device 400 with a part (for example, a part of the action plan generator 140) of the configuration included in the automatic driving control device 100 in the first embodiment.

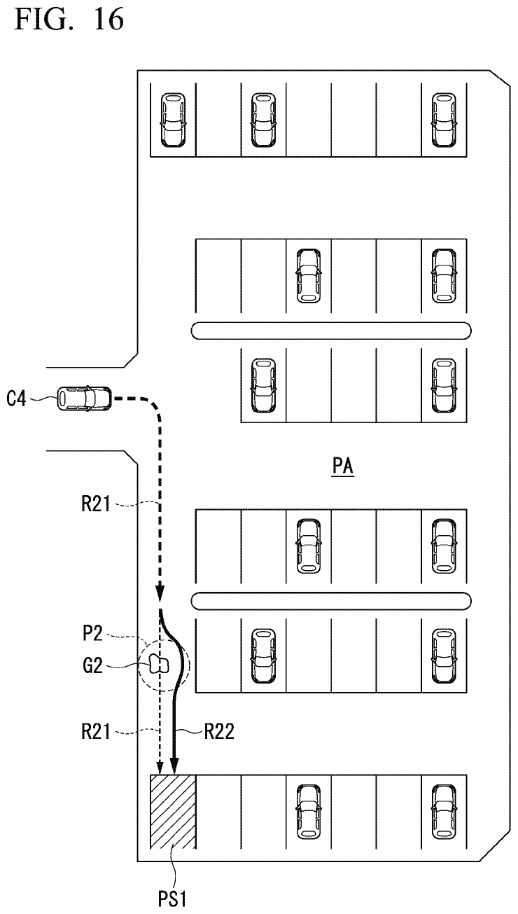

FIG. 16 is a diagram illustrating an example of a travel route when an obstacle exists on a passage. Hereinafter, a description will be given for a travel route on which a fourth vehicle C4, which is an example of the host vehicle M, parks in the parking space PS1. The first route of the fourth vehicle C4 generated by the parking lot management device 400 is, for example, a route R21 from the entrance of the parking lot PA to the parking space PS1 at the shortest distance. The fourth vehicle C4 recognizes the obstacle G2 while traveling on the route R21 while sensing by itself. In such a case, the fourth vehicle C4 generates a target trajectory of a route R22 which is a route that makes a detour the obstacle G2 while sensing by itself and travels on a passage where the obstacle G2 exists, and travels along the generated target trajectory. That is, the fourth vehicle C4 travels along the target trajectory (route R22) generated by itself instead of the target trajectory (route R21) generated by the parking lot management device 400.

Then, the fourth vehicle C4 transmits, to the parking lot management device 400, information on the target trajectory of the route R22 actually traveled and obstacle information on the recognized obstacle G2. The fourth vehicle C4 determines a detour point P2 and transmits information on the determined detour point P2 to the parking lot management device 400.

By so doing, when it is predicted that some abnormality has occurred at the detour point P2, the parking lot management device 400 can instruct a subsequent vehicle to travel along the target trajectory of the route R22. Thus, the subsequent vehicle can travel by making a detour around the obstacle G2. Even when the outside world recognition performance of the subsequent vehicle is low and it is not possible to recognize the obstacle G2, the obstacle G2 can be detoured by traveling along the target trajectory of the route R22.

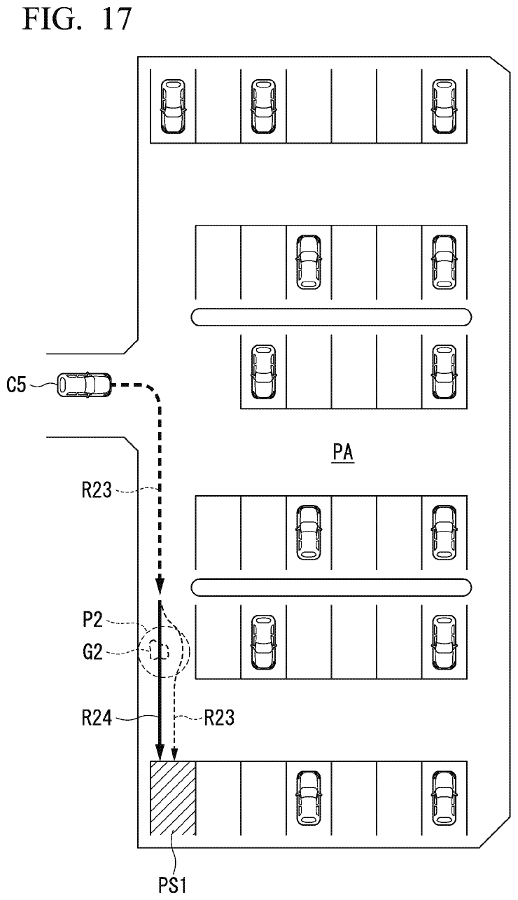

FIG. 17 is a diagram schematically illustrating an example of a travel route after the occurrence of an obstacle is predicted. Hereinafter, a description will be given for a travel route on which a fifth vehicle C5, which is an example of the host vehicle M, parks in the parking space PS1. The first route of the fifth vehicle C5 generated by the parking lot management device 400 is, for example, a route R23 from the entrance of the parking lot PA to the parking space PS1 by making a detour as if the fourth vehicle C4 has actually traveled. The fifth vehicle C5 determines whether the obstacle G2 still exists at the detour point P2 based on the recognition result of the recognizer 130 while traveling on the route R23. When it is recognized that the obstacle G2 exists, the fifth vehicle C5 travels on the route R23 generated by the parking lot management device 400. When it is recognized that the obstacle G2 exists, the fifth vehicle C5 transmits the fact to the parking lot management device 400.

On the other hand, when it is recognized that the obstacle G2 does not exist at the detour point P2, the fifth vehicle C5 may generate a target trajectory (route R24) that goes straight on the detour point P2 while sensing by itself and travel along the generated target trajectory. That is, the fifth vehicle C5 travels along the target trajectory (route R24) generated by itself instead of the target trajectory (route R23) generated by the parking lot management device 400. Then, the fifth vehicle C5 transmits information on the target trajectory of the route R24 actually traveled to the parking lot management device 400. The fifth vehicle C5 transmits, to the parking lot management device 400, a notification (removal notification) that the obstacle G2 does not exist.

By so doing, after the obstacle is removed, the parking lot management device 400 can generate a route that makes no detour as before and guide the vehicle.

[Hardware Configuration]

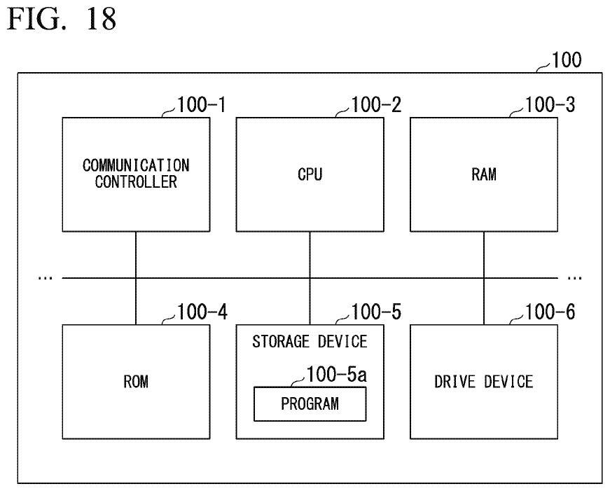

FIG. 18 is a diagram illustrating an example of a hardware configuration of the automatic driving control device 100 of an embodiment. As illustrated in FIG. 18, the automatic driving control device 100 has a configuration in which a communication controller 100-1, a CPU 100-2, a random access memory (RAM) 100-3 used as a working memory, a read only memory (ROM) 100-4 for storing a boot program and the like, a storage device 100-5 such as a flash memory and a hard disk drive (HDD), a driver device 100-6, and the like are connected to one another by an internal bus or a dedicated communication line. The communication controller 100-1 communicates with components other than the automatic driving control device 100. The storage device 100-5 stores a program 100-5a that is executed by the CPU 100-2. The program is developed to the RAM 100-3 by a direct memory access (DMA) controller (not illustrated) and the like, and is executed by the CPU 100-2. In this way, some or all of the first controller 120 and the second controller 160 are implemented.

The aforementioned embodiment can be represented as follows.

A management device includes a storage device that stores a program and a hardware processor, and when the hardware processor executes the program stored in the storage device, the management device is configured to generate a route for guiding a vehicle capable of automatically traveling, transmit information on the generated route to the vehicle, receive information on a route on which the vehicle has actually traveled from the vehicle, generate a third route based on a second route on which a first vehicle has actually traveled with respect to a second vehicle that passes through the same two or more points as the first vehicle after the first vehicle when a first route generated as a route of the first vehicle is different from the second route, and transmit information on the third route to the second vehicle.

Although a mode for carrying out the present invention has been described using the embodiments, the present invention is not limited to these embodiments and various modifications and substitutions can be made without departing from the spirit of the present invention.

For example, the first embodiment has described an example in which a route that does not pass through the detour point recognized to have an obstacle is generated as the detour route; however, the present invention is not limited thereto. For example, as described in the second embodiment, the detour route may be a passage recognized to have an obstacle and run next to the obstacle. In such a case, the parking lot management device 400 receives a target trajectory of a detoured route from a vehicle as a second route actually traveled and transmits the target trajectory of the detoured route to a subsequent vehicle together with a rough route, thereby instructing the subsequent vehicle to travel on the detoured route.

The second embodiment has described an example in which the detour route is a passage recognized to have an obstacle and runs next to an obstacle; however, the present invention is not limited thereto. For example, as described in the first embodiment, a route that does not pass through the detour point recognized to have an obstacle may be generated as the detour route.

Although an example in which the target parking spaces of the first vehicle C1 (or the fourth vehicle C4) and the second vehicle C2 (or the fifth vehicle C5) are the same has been described, the present invention is not limited thereto. For example, as in a case where the target parking space of the second vehicle C2 is a parking space next to the parking space PS1, when routes to the target parking space are partially the same, the route generator 421 may generate the third route as a route of the second vehicle C2 (or the fifth vehicle C5) based on an actual travel route of the first vehicle C1 (or the fourth vehicle C4).

What is claimed is:

1. A management device that guides a vehicle capable of automatically traveling, comprising:
a generator that generates a route for guiding the vehicle; and
a communicator that transmits information on the generated route to the vehicle and receives information on a route on which the vehicle has actually traveled from the vehicle,
wherein, when a first route generated as a route of a first vehicle is different from a second route on which the first vehicle has actually traveled, the generator generates a third route based on the second route, and
the communicator transmits information on the third route to a second vehicle that passes through the same two or more points as the first vehicle after the first vehicle.

2. The management device according to claim 1,
wherein the generator generates a route of the second vehicle, and when the generated route of the second vehicle overlaps at least a part of the first route generated as the route of the first vehicle, the generator generates the third route by correcting the route of the second vehicle based on the second route.

3. The management device according to claim 1,
wherein the generator generates a route of the second vehicle, and when the generated route of the second vehicle includes a detour point that is an interruption point of traveling along the first route generated as the route of the first vehicle and is a start point of the second route, the generator generates the third route by correcting the route of the second vehicle based on the second route.

4. The management device according to claim 1, further comprising:
a predictor that predicts that an abnormality has occurred when the number of vehicles, in which the route generated by the generator is different from the actually traveled route, exceeds a predetermined number.

5. The management device according to claim 4,
wherein the predictor predicts that an abnormality has occurred in a passage in which the vehicle is traveling.

6. The management device according to claim 4,
wherein, when the abnormality predicted by the predictor is resolved, the generator generates a route similarly to a case where no abnormality is predicted by the predictor.

7. The management device according to claim 1, further comprising:
an inter-vehicle adjustor that, when the first route and the second route are different from each other, allows a vehicle with high outside world detection performance to travel with higher priority than a vehicle with low outside world detection performance among a plurality of vehicles that pass through the same two or more points as the first vehicle,
wherein the generator generates the third route based on a route on which the vehicle with high outside world detection performance has actually traveled.

8. The management device according to claim 1, wherein, when the first route and the second route are different from each other, the management device allows a probe car with high outside world detection performance to travel and generates the third route based on a route on which the probe car has actually traveled.

9. A management method implemented by a computer performing the steps of:
generating a route for guiding a vehicle capable of automatically traveling;
transmitting information on the generated route to the vehicle;
receiving information on a route on which the vehicle has actually traveled from the vehicle;
generating a third route based on a second route on which the first vehicle has actually traveled when a first route generated as a route of a first vehicle is different from the second route; and
transmitting information on the third route to a second vehicle that passes through the same two or more points as the first vehicle after the first vehicle.

10. A computer readable non-transitory storing medium storing a program causing a computer to perform the steps of:
generating a route for guiding a vehicle capable of automatically traveling;
transmitting information on the generated route to the vehicle;
receiving information on a route on which the vehicle has actually traveled from the vehicle;
generating a third route based on a second route on which the first vehicle has actually traveled when a first route generated as a route of a first vehicle is different from the second route; and
transmitting information on the third route to a second vehicle that passes through the same two or more points as the first vehicle after the first vehicle.
